(19) United States
(12) Patent Application Publication
(10) Pub. No.: US 2007/0188682 A1
(43) Pub. Date: Aug. 16, 2007

(54) METHOD FOR MANUFACTURING A DISPLAY DEVICE

(76) Inventors: Masaru Takabatake, Mobara (JP); Toshiki Kaneko, Chiba (JP); Hideo Tanabe, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/674,767

(22) Filed: Feb. 14, 2007

(30) Foreign Application Priority Data
Feb. 14, 2006 (JP) 2006-036804

(51) Int. Cl. G02F 1/1335

(52) U.S. Cl. 349/114

(57) ABSTRACT

In a liquid crystal display device with a reflective area and a transmissive area, a reflective electrode and a transmissive electrode are manufactured without an extra process.

A metal layer that forms the reflective electrode and a transparent conductive film that forms the transmissive electrode are successively laminated on pixels, each having the transmissive area and the reflective area. A resist film is exposed to light followed by development to form a first pattern so as to simultaneously etch the metal layer and the transparent conductive film. Thereafter, ashing is used to form a second pattern in the resist film so as to etch the metal layer. An organic resin layer is used as a mask to form a contact hole.

### BACKGROUND OF THE INVENTION

1. Field of the Invention

The present invention relates to a method for manufacturing a display device, and particularly to a method for manufacturing a transreflective liquid crystal display device with two conductive film layers on a resin insulating film.

2. Description of the Related Art

In recent years, a so-called transreflective liquid crystal display device in which two kinds of display operations are performed, that is, a reflective display operation and a transmissive display operation, is frequently used, for example, as the display of a mobile apparatus. The transreflective liquid crystal display device includes a transmissive area and a reflective area in one pixel. A transmissive mode and a reflective mode are mixed in the transreflective display operation. In the transmissive mode, the transmissive area provided in the pixel transmits light to the eyes of the viewer. In the reflective mode, the reflective area reflects light to the eyes of the viewer.

The transreflective liquid crystal display device, when used in a bright ambient environment, for example, in the case of outdoor use, is intended to use the ambient light by performing the reflective mode display operation in conjunction with the transmissive mode display operation.

A transmissive liquid crystal display device has a problem of reduced visibility when used under the very bright ambient light, for example, when used outdoors under sunny conditions. On the other hand, a reflective liquid crystal display device has a problem of significantly reduced visibility when used under dim ambient light.

To solve these problems, the transreflective liquid crystal display device has both the reflective and transmissive display capabilities.

In the transreflective liquid crystal display device, the active matrix method is widely used, in which a thin film transistor (hereinafter referred to as a TFT) is used as a switching element for selectively supplying an image signal to a pixel electrode.

The TFT active matrix liquid crystal display device includes a TFT substrate on which TFTs and pixel electrodes are formed, a color filter substrate on which color filters for color display are disposed opposite to the TFT substrate, and liquid crystal composition material encapsulated between these substrates. On the TFT substrate, a plurality of image signal lines and a plurality of scan lines intersecting each other are provided, and a plurality of areas partitioned by the image signal lines and the scan lines are arranged in a matrix. Each of the areas area provided with the TFT and the pixel electrode.

In the liquid crystal display device, a counter electrode is provided opposite to the pixel electrode. An electric field is generated between the pixel electrode and the counter electrode to change the orientation of the liquid crystal molecules, and the resultant change in the characteristic of the liquid crystal layer with respect to light is used to perform display operations.

In general, there are known a vertical electric field method in which the counter electrode is provided on the color filter substrate and an IPS (In-plan Switching) method in which the counter electrode is provided on the TFT substrate.

Some transreflective liquid crystal display devices use an organic resin film as an insulating film. In the transreflective liquid crystal display device, the thickness of the liquid crystal layer in the reflective area needs to be half of that in the transmissive area. Thus, the organic resin film is provided as a thick interlayer insulating film in the reflective area in order to reduce the thickness of the liquid crystal layer.

The transreflective liquid crystal display device uses a light-reflecting conductive film, such as a metal film, in the reflective area, and a light-transmitting conductive film, such as a transparent conductive film, in the transmissive area. Thus, each pixel section has two conductive film layers, thereby creating a problem of extra processes required for patterning the respective conductive films.

For example, JP-A-2005-259371 proposes a method for manufacturing a transreflective liquid crystal display device.

### SUMMARY OF THE INVENTION

In the transreflective liquid crystal display device, the transmissive area and the reflective area are formed in one pixel, thereby creating a problem of extra processes required for patterning the transparent conductive film in the transmissive area and the metal film in the reflective area.

The invention has been made in view of the above circumstances and aims to provide a method for manufacturing a transreflective liquid crystal display device in which two layers of conductive films are patterned into predetermined shapes while preventing the number of processes from increasing.

There is provided a method for manufacturing a display device having a transparent conductive film and a reflective film in a pixel. The method includes the steps of: laminating a first insulating film and a second insulating film on a source electrode of a transistor in a pixel section; forming a contact hole in the first and second insulating films; laminating a transparent conductive film and a reflective film on the first and second insulating films and connecting the source electrode to the transparent conductive film and the reflective film via the contact hole; using a first pattern of a resist film to etch the transparent conductive film and the reflective film; removing part of the resist film to form a second pattern; and using the second pattern to etch the second reflective film so as to remove the reflective film from the transmissive area.

The invention in this application is characterized in that in a transreflective liquid crystal display device, the applied, exposed and developed resist film is shaped into a plurality of patterns in consideration of the number of processes, so as to prevent the number of processes from increasing.

According to the invention in this application, in a liquid crystal display device with a reflective area and a transmissive area, it is possible to prevent the number of processes from increasing.

### BRIEF DESCRIPTION OF THE DRAWINGS

FIG. 1 is a plan view showing the schematic configuration of the liquid crystal display device that is an embodiment of the invention;

FIG. 2 is a schematic plan view showing the pixel section of the liquid crystal display device that is the embodiment of the invention;

FIG. 3 a schematic cross-sectional view showing the pixel section of the liquid crystal display device that is the embodiment of the invention;

FIG. 4 is a schematic cross-sectional view showing the pixel section and the drain signal line of the liquid crystal display device that is the embodiment of the invention;

FIG. 5A is a schematic cross-sectional view showing a manufacturing process of the pixel section of the liquid crystal display device that is the embodiment of the invention;

FIG. 5B is a schematic cross-sectional view subsequent to FIG. 5A, showing a manufacturing process of the pixel section of the liquid crystal display device that is the embodiment of the invention;

FIG. 5C is a schematic cross-sectional view subsequent to FIG. 5B, showing a manufacturing process of the pixel section of the liquid crystal display device that is the embodiment of the invention;

FIG. 5D is a schematic cross-sectional view subsequent to FIG. 5C, showing a manufacturing process of the pixel section of the liquid crystal display device that is the embodiment of the invention;

FIG. 5E is a schematic cross-sectional view subsequent to FIG. 5D, showing a manufacturing process of the pixel section of the liquid crystal display device that is the embodiment of the invention;

FIG. 5F is a schematic cross-sectional view subsequent to FIG. 5E, showing a manufacturing process of the pixel section of the liquid crystal display device that is the embodiment of the invention;

FIG. 5G is a schematic cross-sectional view subsequent to FIG. 5F, showing a manufacturing process of the pixel section of the liquid crystal display device that is the embodiment of the invention;

FIG. 5H is a schematic cross-sectional view subsequent to FIG. 5G, showing a manufacturing process of the pixel section of the liquid crystal display device that is the embodiment of the invention;

FIG. 5I is a schematic cross-sectional view subsequent to FIG. 5H, showing a manufacturing process of the pixel section of the liquid crystal display device that is the embodiment of the invention;

FIG. 5J is a schematic cross-sectional view subsequent to FIG. 5I, showing a manufacturing process of the pixel section of the liquid crystal display device that is the embodiment of the invention;

FIG. 6A is a schematic cross-sectional view showing a manufacturing process of the pixel section of the liquid crystal display device that is the embodiment of the invention;

FIG. 6B is a schematic cross-sectional view subsequent to FIG. 6A, showing a manufacturing process of the pixel section of the liquid crystal display device that is the embodiment of the invention;

FIG. 6C is a schematic cross-sectional view subsequent to FIG. 6B, showing a manufacturing process of the pixel section of the liquid crystal display device that is the embodiment of the invention;

FIG. 6D is a schematic cross-sectional view subsequent to FIG. 6C, showing a manufacturing process of the pixel section of the liquid crystal display device that is the embodiment of the invention;

FIG. 6E is a schematic cross-sectional view subsequent to FIG. 6D, showing a manufacturing process of the pixel section of the liquid crystal display device that is the embodiment of the invention;

FIG. 6F is a schematic cross-sectional view subsequent to FIG. 6E, showing a manufacturing process of the pixel section of the liquid crystal display device that is the embodiment of the invention;

FIG. 7A is a schematic cross-sectional view showing a manufacturing process of the pixel section and the drain signal line of the liquid crystal display device that is the embodiment of the invention;

FIG. 7B is a schematic cross-sectional view subsequent to FIG. 7A, showing a manufacturing process of the pixel section and the drain signal line of the liquid crystal display device that is the embodiment of the invention;

FIG. 7C is a schematic cross-sectional view subsequent to FIG. 7B, showing a manufacturing process of the pixel section and the drain signal line of the liquid crystal display device that is the embodiment of the invention;

FIG. 7D is a schematic cross-sectional view subsequent to FIG. 7C, showing a manufacturing process of the pixel section and the drain signal line of the liquid crystal display device that is the embodiment of the invention;

FIG. 7E is a schematic cross-sectional view subsequent to FIG. 7D, showing a manufacturing process of the pixel section and the drain signal line of the liquid crystal display device that is the embodiment of the invention;

FIG. 8A is a schematic cross-sectional view showing a manufacturing process of the connection terminals of the liquid crystal display device that is the embodiment of the invention;

FIG. 8B is a schematic cross-sectional view subsequent to FIG. 8A, showing a manufacturing process of the connection terminals of the liquid crystal display device that is the embodiment of the invention;

FIG. 8C is a schematic cross-sectional view subsequent to FIG. 8B, showing a manufacturing process of the connection terminals of the liquid crystal display device that is the embodiment of the invention;

FIG. 8D is a schematic cross-sectional view subsequent to FIG. 8C, showing a manufacturing process of the connection terminals of the liquid crystal display device that is the embodiment of the invention;

FIG. 8E is a schematic cross-sectional view subsequent to FIG. 8D, showing a manufacturing process of the connection terminals of the liquid crystal display device that is the embodiment of the invention;

FIG. 8F is a schematic cross-sectional view subsequent to FIG. 8E, showing a manufacturing process of the connection terminals of the liquid crystal display device that is the embodiment of the invention;

FIG. 8G is a schematic cross-sectional view subsequent to FIG. 8F, showing a manufacturing process of the connection terminals of the liquid crystal display device that is the embodiment of the invention;

FIG. 8H is a schematic cross-sectional view subsequent to FIG. 8G, showing a manufacturing process of the connection terminals of the liquid crystal display device that is the embodiment of the invention;

FIG. 9A is a schematic cross-sectional view showing a manufacturing process of the connection terminal of the liquid crystal display device that is the embodiment of the invention;

FIG. 9B is a schematic cross-sectional view subsequent to FIG. 9A, showing a manufacturing process of the connection terminal of the liquid crystal display device that is the embodiment of the invention;

FIG. 9C is a schematic cross-sectional view subsequent to FIG. 9B, showing a manufacturing process of the connection terminal of the liquid crystal display device that is the embodiment of the invention;

FIG. 9D is a schematic cross-sectional view subsequent to FIG. 9C, showing a manufacturing process of the connection terminal of the liquid crystal display device that is the embodiment of the invention;

FIG. 9E is a schematic cross-sectional view subsequent to FIG. 9D, showing a manufacturing process of the connection terminal of the liquid crystal display device that is the embodiment of the invention;

FIG. 9F is a schematic cross-sectional view subsequent to FIG. 9E, showing a manufacturing process of the connection terminal of the liquid crystal display device that is the embodiment of the invention;

FIG. 10A is a schematic cross-sectional view showing the schematic configuration of the pixel section and the connection terminals of the liquid crystal display device that is the embodiment of the invention;

FIG. 10B is a schematic cross-sectional view subsequent to FIG. 10A, showing the schematic configuration of the pixel section and the connection terminals of the liquid crystal display device that is the embodiment of the invention;

FIG. 11A is a schematic cross-sectional view showing a manufacturing process of the pixel section of the liquid crystal display device that is the embodiment of the invention;

FIG. 11B is a schematic cross-sectional view subsequent to FIG. 11A, showing a manufacturing process of the pixel section of the liquid crystal display device that is the embodiment of the invention;

FIG. 11C is a schematic cross-sectional view subsequent to FIG. 11B, showing a manufacturing process of the pixel section of the liquid crystal display device that is the embodiment of the invention;

FIG. 11D is a schematic cross-sectional view subsequent to FIG. 11C, showing a manufacturing process of the pixel section of the liquid crystal display device that is the embodiment of the invention;

FIG. 11E is a schematic cross-sectional view subsequent to FIG. 11D, showing a manufacturing process of the pixel section of the liquid crystal display device that is the embodiment of the invention;

FIG. 11F is a schematic cross-sectional view subsequent to FIG. 11E, showing a manufacturing process of the pixel section of the liquid crystal display device that is the embodiment of the invention;

FIG. 11G is a schematic cross-sectional view subsequent to FIG. 11F, showing a manufacturing process of the pixel section of the liquid crystal display device that is the embodiment of the invention;

FIG. 11H is a schematic cross-sectional view subsequent to FIG. 11G, showing a manufacturing process of the pixel section of the liquid crystal display device that is the embodiment of the invention;

FIG. 11I is a schematic cross-sectional view subsequent to FIG. 11H, showing a manufacturing process of the pixel section of the liquid crystal display device that is the embodiment of the invention;

FIG. 12 is a schematic plan view showing the configuration of the pixel section of the liquid crystal display device that is an embodiment of the invention;

FIG. 13A is a schematic cross-sectional view showing a manufacturing process of the pixel section of the liquid crystal display device that is the embodiment of the invention;

FIG. 13B is a schematic cross-sectional view subsequent to FIG. 13A, showing a manufacturing process of the pixel section of the liquid crystal display device that is the embodiment of the invention;

FIG. 13C is a schematic cross-sectional view subsequent to FIG. 13B, showing a manufacturing process of the pixel section of the liquid crystal display device that is the embodiment of the invention;

FIG. 13D is a schematic cross-sectional view subsequent to FIG. 13C, showing a manufacturing process of the pixel section of the liquid crystal display device that is the embodiment of the invention; and

FIG. 13E is a schematic cross-sectional view subsequent to FIG. 13D, showing a manufacturing process of the pixel section of the liquid crystal display device that is the embodiment of the invention.

### DETAIL DESCRIPTION OF THE EMBODIMENTS

There is provided a method for manufacturing a liquid crystal display device having a reflective area and a transmissive area in each pixel section. The method includes the steps of forming a source electrode of a transistor in the pixel section, forming a first insulating film on the source electrode, laminating a second insulating film made of resin on the first insulating film, exposing the second insulating film to light followed by development to form a pattern having a first contact hole in the second insulating film, using the pattern having the first contact hole to form a second contact hole in the second insulating film, laminating a first conductive film and a second conductive film on the first and second insulating films and connecting the source electrode to the first conductive film via the first and second contact holes, applying a resist film on the first and second conductive films, exposing the resist film to light followed by development to form a first pattern, using the first pattern of the resist film to etch the first and second conductive films, using ashing to remove part of the resist film to form a second pattern, and using the second pattern to etch the second conductive film.

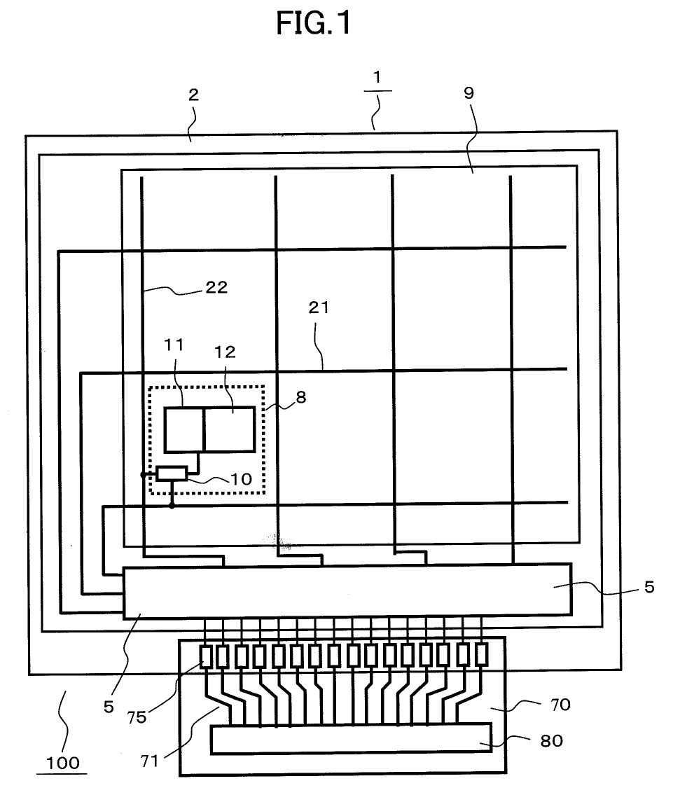

FIG. 1 is a plan view showing the liquid crystal display device 100 according to the invention. The liquid crystal display device 100 includes a liquid crystal panel 1 and a control circuit 80. The control circuit 80 supplies signals required for performing display operations for the liquid crystal panel 1. The control circuit 80 is implemented on a flexible substrate 70 and the signals are transmitted to the liquid crystal panel 1 via wiring lines 71 and terminals 75.

Each pixel section 8 in the liquid crystal panel 1 has a reflective area 11 and a transmissive area 12. Although the liquid crystal panel 1 has a large number of pixel sections 8 arranged in a matrix, only one pixel section is illustrated in FIG. 1 for clarity. The pixel sections 8 arranged in a matrix form a display area 9 and each pixel section 8 serves as a pixel of an image to be displayed, so that the image is displayed in the display area 9.

In FIG. 1, there are provided gate signal lines (also referred to as scan lines) 21 extending in the x direction and juxtaposed in the y direction in the figure as well as drain signal lines (also referred to as image signal lines) 22 extending in the y direction and juxtaposed in the x direction in the figure. The pixel section 8 is formed in the area surrounded by the gate signal line 21 and the drain signal line 22.

A switching element 10 is provided in the pixel section 8. The gate signal line 21 supplies a control signal to turn the switching element 10 on and off. When the switching element 10 is turned on, an image signal transmitted via the drain signal line 22 is supplied to the reflective area 11 and the transmissive area 12.

The gate signal lines 21 and the drain signal lines 22 are connected to a drive circuit 5, which outputs the control signal and the image signal. The gate signal lines 21, the drain signal lines 22 and the drive circuit 5 are formed on the same TFT substrate 2.

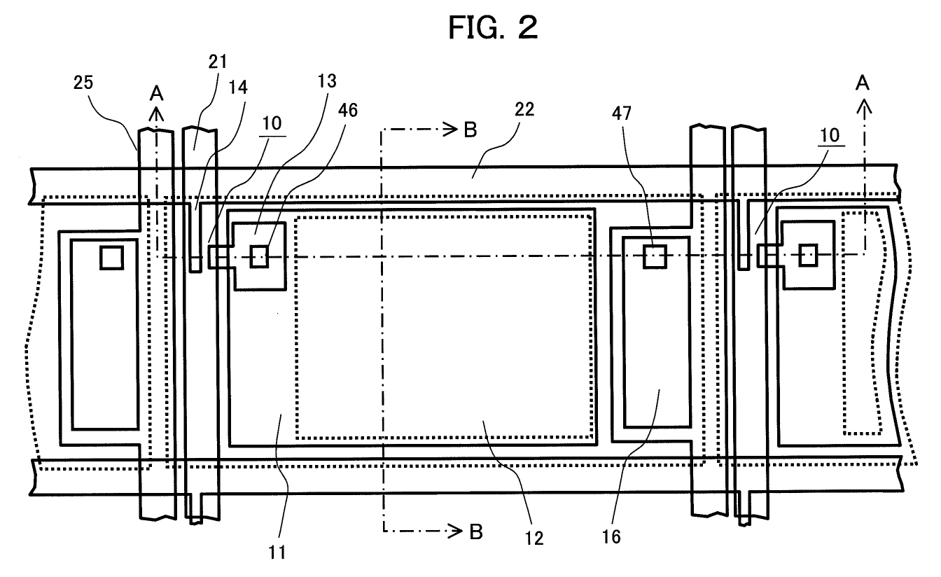

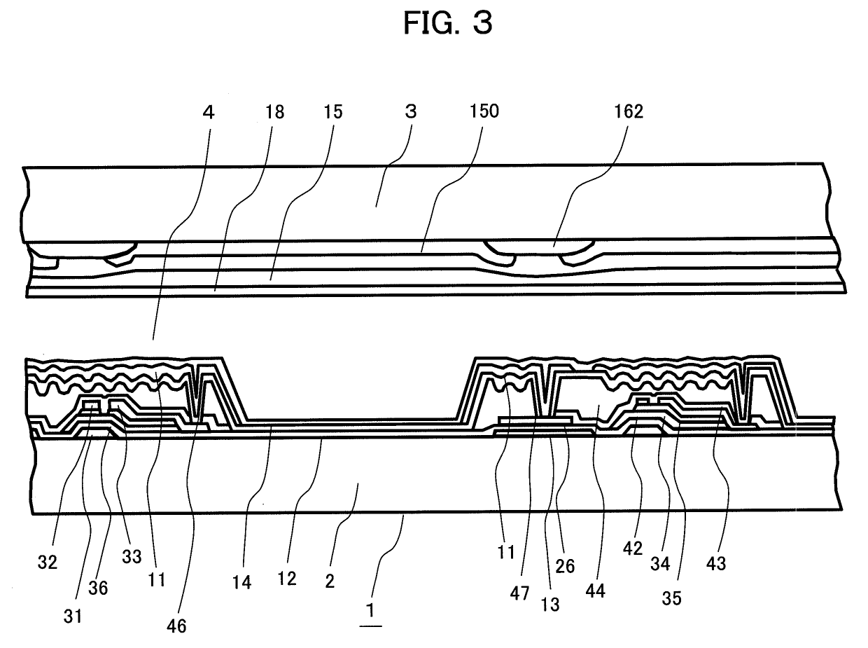

FIG. 2 is a plan view of the pixel section 8. FIG. 3 is a cross-sectional view taken along the line A-A shown in FIG. 2. FIGS. 2 and 3 show the pixel section 8 in a vertical electric field-type liquid crystal panel. A counter electrode 15 is formed on a color filter substrate 3 such that the counter electrode 15 faces the reflective area 11 (hereinafter also referred to as a reflective electrode) and the transmissive area 12 (hereinafter also referred to as a transmissive electrode).

A color filter 150 is formed on the color filter substrate 3 for each color, that is, red (R), green (G) and blue (B), and a black matrix 162 is formed at the boundary of the color filter 150 to block light.

In FIG. 2, a capacitance line 25 is formed parallel to the gate signal line 21, and the end of the reflective area 11 passes over the gate signal line 21 and overlaps with the capacitance line 25. The gate signal line 21 and the drain signal line 22 are parallel to the respective ends of the reflective area 11.

The reflective area 11 is shaped to surround the transmissive area 12. The reflective area 11 is typically made of opaque metal, such as aluminum, so that the reflective area 11 serves as a light blocking film for the transmissive area 12.

In FIG. 2, the reflective area 11 is indicated by dotted lines in order to clearly show the configuration of the pixel section 8.

The switching element 10 (hereinafter also referred to as a thin film transistor or TFT) is formed in the vicinity of the intersection of the gate signal line 21 and the drain signal line 22. The TFT 10 is turned on by a gate signal supplied via the gate signal line 21, so that the image signal supplied via the drain signal line 22 is written to the transmissive electrode, which forms the transmissive area 12, and the reflective electrode, which forms the reflective area 11.

FIG. 3 is a cross-sectional view taken along the line A-A shown in FIG. 2. The liquid crystal panel 1 is configured such that the TFT substrate 2 and the color filter substrate 3 face each other. Liquid crystal composition material 4 is held between the TFT substrate 2 and the color filter substrate 3. A sealant (not shown) is provided at the peripheries of the TFT substrate 2 and the color filter substrate 3, and the TFT substrate 2, the color filter substrate 3 and the sealant form a chamber having a narrow gap. The liquid crystal composition material 4 is encapsulated between the TFT substrate 2 and the color filter substrate 3. Reference numerals 14 and 18 denote orientation films that control the orientation of the liquid crystal molecules.

At least part of the TFT substrate 2 is made of transparent glass, resin, semiconductor or the like. As described above, the gate signal lines 21 are formed on the TFT substrate 2. The gate signal line 21 is formed of a multilayered film including a layer primarily made of chromium (Cr) or zirconium (Zr) and a layer primarily made of aluminum (Al). The sides of the gate signal line 21 are inclined such that the width of the line expands in the direction from the top toward the TFT substrate-side bottom. Part of the gate signal line 21 forms a gate electrode 31. A gate insulating film 36 is formed to cover the gate electrode 31, and a semiconductor layer 34 formed of an amorphous silicon film is formed on the gate insulating film 36. An impurity is added to the top of the semiconductor layer 34 to form an n+ layer 35. The n+ layer 35 is an ohmic contact layer and formed to achieve electrically excellent connection to the semiconductor layer 34. A drain electrode 32 and a source electrode 33 are formed on the semiconductor n+ layer 35 in such a way that the electrodes are spaced apart from each other. Although the nomenclature of “drain” and “source” depends on their potential, “drain” used herein refers to that connected to the drain signal line 22.

Each of the drain signal line 22, the drain electrode 32 and the source electrode 33 is formed of a multilayered film including two layers primarily made of an alloy of molybdenum (Mo) and chromium (Cr), molybdenum (Mo) or tungsten (W) and a layer primarily made of aluminum between the two layers. The source electrode 33 is electrically connected to the transmissive area 12 and the reflective area 11. An inorganic insulating film 43 and an organic insulating film 44 are formed to cover the TFT 10. The source electrode 33 is connected to the reflective area 11 and the transmissive area 12 via a through hole 46 formed in the inorganic insulating film 43 and the organic insulating film 44. The inorganic insulating film 43 can be made of silicon nitride or silicon oxide, and the organic insulating film 44 can be an organic resin film. The surface of the organic insulating film 44 maybe formed to be relatively flat or may be processed to form projections and depressions.

The reflective area 11, which is formed of the reflective electrode, includes an exit-side conductive film made of high light-reflectance metal, such as aluminum, as well as a multilayered film including a layer primarily made of tungsten or chromium and a layer primarily made of aluminum. The transmissive area 12 is formed of a transparent conductive film. In some cases in the following description, reference numeral 11 denotes the reflective electrode and reference numeral 12 denotes to the transparent electrode.

The transparent conductive film is formed of a light-transmitting conductive layer made of ITO (indium tin oxide), ITZO (Indium Tin Zinc Oxide), IZO (Indium Zinc oxide), ZnO (Zinc oxide), SnO (tin oxide), In₂O₃ (indium oxide) or the like.

The layer primarily made of chromium may be made of chromium alone or an alloy of chromium, molybdenum (Mo) and the like. The layer primarily made of zirconium may be made of zirconium alone or an alloy of zirconium, molybdenum and the like. The layer primarily made of tungsten may be made of tungsten alone or an alloy of tungsten, molybdenum and the like. The layer primarily made of aluminum may be made of aluminum alone or an alloy of aluminum, neodymium and the like.

The organic insulating film 44 has projections and depressions formed by using photolithography or the like. Thus, the reflective electrode 11 formed on the organic insulating film 44 also has projections and depressions. The reflective electrode 11 with such projections and depressions scatters more reflected light.

The organic insulating film 44 and the inorganic insulating film 43 on the transmissive electrode 12 are removed to form an aperture. The reflective electrode 11 is formed to surround the outer circumference of the aperture. The sides wall of the aperture adjacent to the transmissive electrode 12 side are inclined, and the reflective electrode 11 is formed on the inclined portion and electrically connected to the vicinity of the outer circumference of the transparent electrode 12.

The capacitance line 25 is connected to a storage capacitive portion 13. A storage capacitance electrode 26 is provided opposite to the storage capacitive portion 13 with the inorganic insulating film 43 sandwiched therebetween, so that the storage capacitive portion 13 and the storage capacitance electrode 26 form storage capacitance. The storage capacitance electrode 26 is connected to the reflective electrode 11 via a through hole 47 provided in the organic insulating film 44.

The storage capacitive portion 13 can be formed in the same process and using the same material as the gate signal line 21, as in the case of the capacitance line 25. Similarly, the storage capacitance electrode 26 can be formed in the same process and using the same material as the drain signal line 22. The storage capacitance electrode 26 may be connected to the transparent electrode 12 instead of the reflective electrode 11 to perform the function of the storage capacitance electrode.

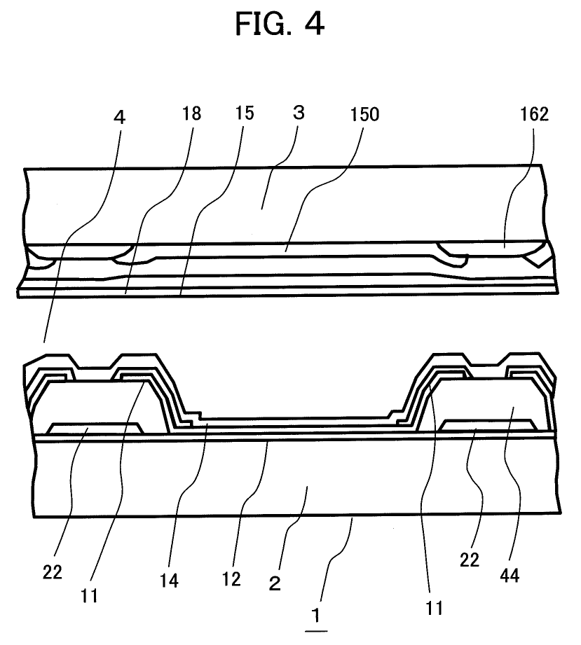

Next, FIG. 4 shows the cross section taken along the line B-B shown in FIG. 2. The transparent electrode 12 is disposed between the two drain signal lines 22. The organic insulating film 44 is formed to cover the drain signal lines 22, and the reflective electrode 11 is formed on the organic insulating film 44. The reflective electrode 11 is also formed on the inclined portion formed at the sides wall of the organic insulating film 44, reaches the top of the transparent electrode 12 and is electrically connected thereto.

As shown in FIG. 4, the reflective electrode 11 is formed in the narrow areas on the drain signal lines 22. The reflective electrode 11 surrounds the transparent electrode 12 disposed at the center of the pixel and hence serves as a light blocking film.

In the reflective electrode 11, the surface as a reflective film is formed of a conductive film primarily made of aluminum, while the surface electrically connected to the transparent conductive film is made of an alloy of chromium and molybdenum, an alloy of tungsten and molybdenum or the like in order to reduce the electric resistance of the contact portion.

The reflective electrode 11, which is formed to surround the transparent electrode 12, is also used to electrically connect the through holes 46 and 47 provided on the opposite sides of the transparent electrode 12. By forming the reflective electrode 11 to surround the transparent electrode 12 and using the low-resistance reflective electrode 11 to supply the image signal to the transparent electrode 12 from the surrounding portion, the transparent electrode 12 can be brought into a uniform potential state in a short period of time, resulting in improved display quality.

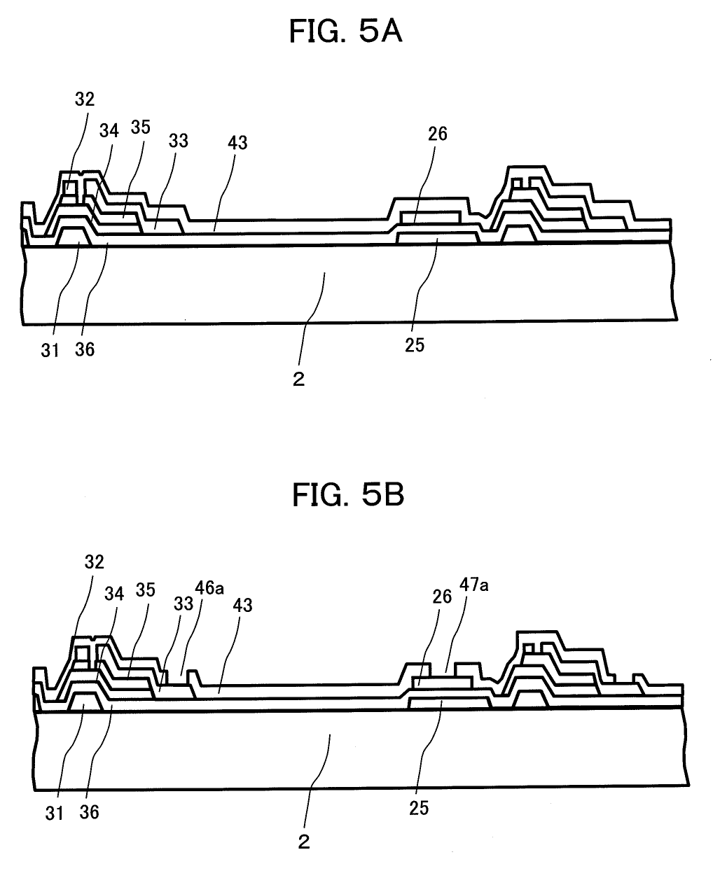

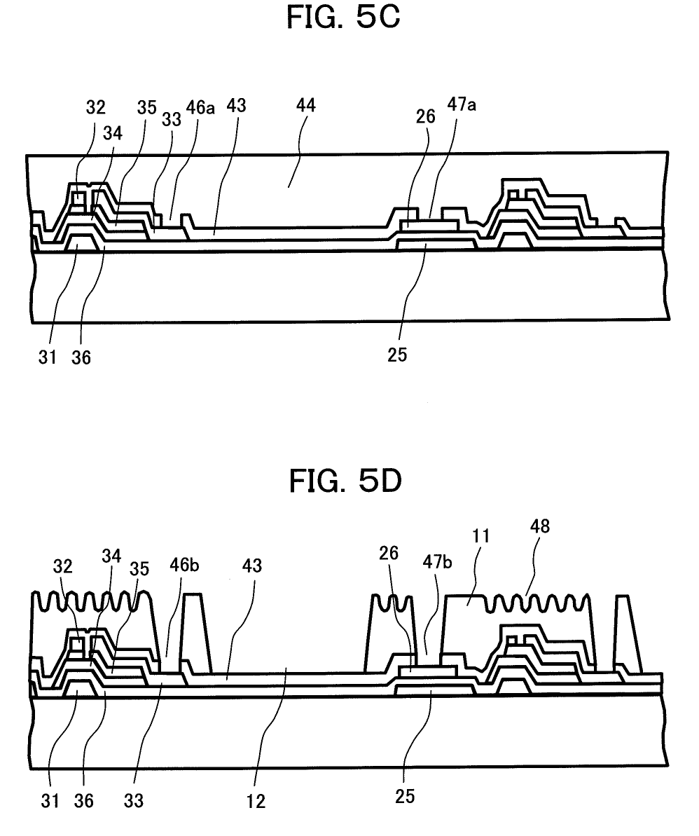

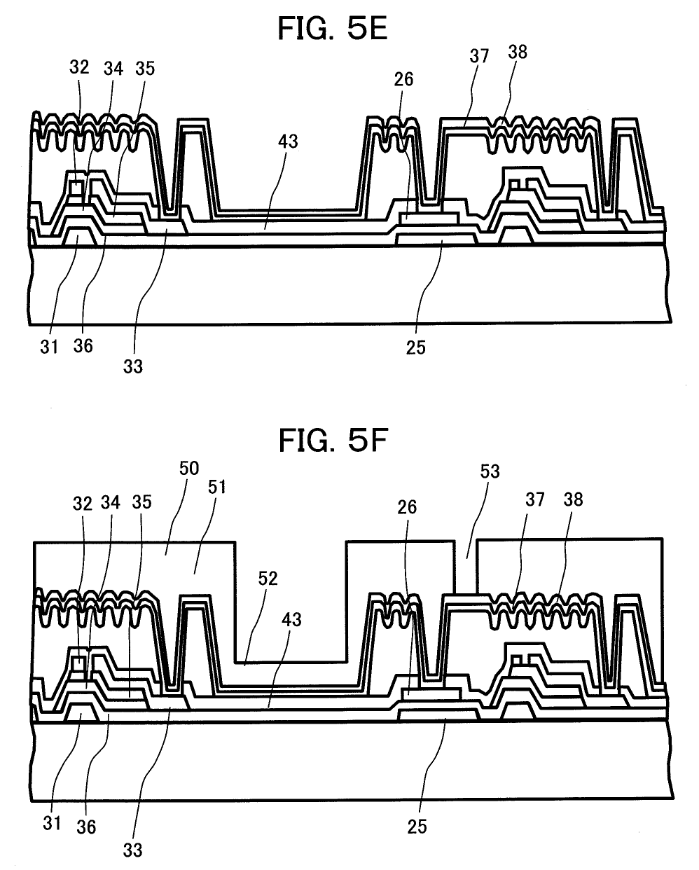

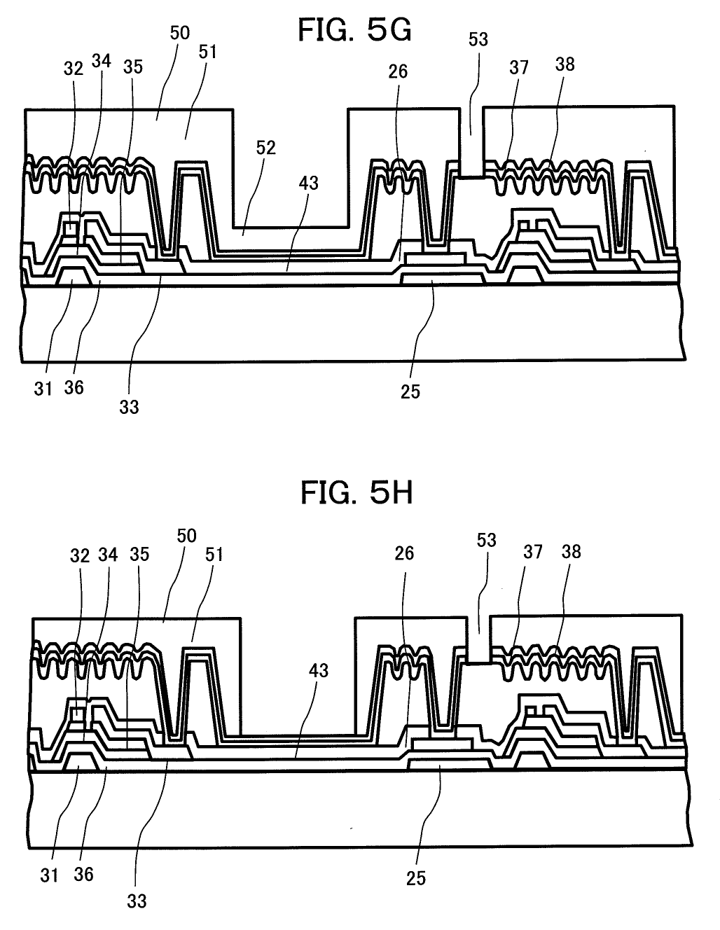

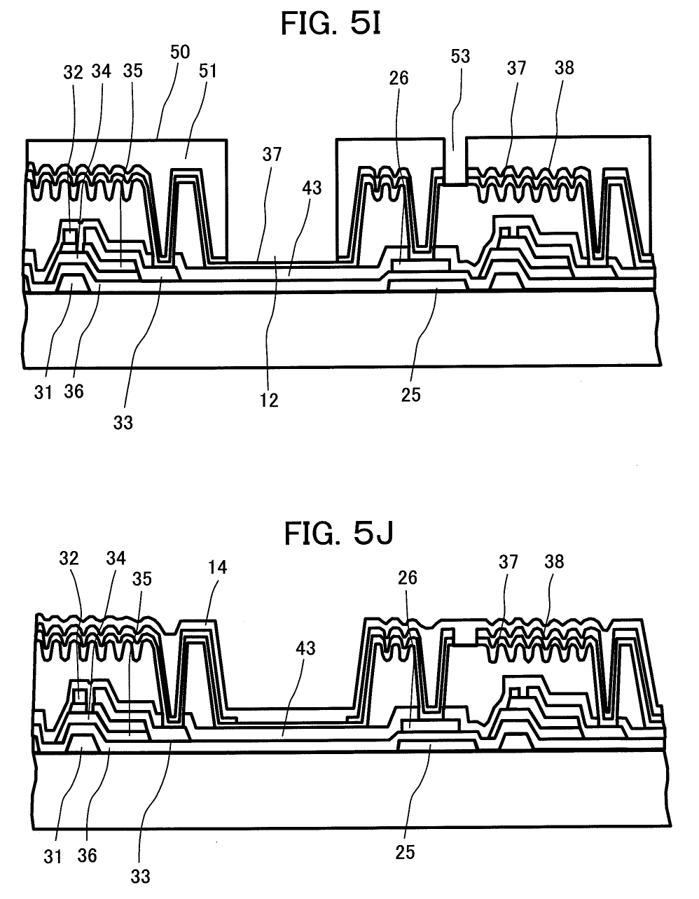

A process for forming the reflective electrode 11 and the transparent electrode 12 will now be described with reference to FIGS. 5A to 5J. In the process shown in FIG. 5A, the gate electrode 31, the gate insulating film 36, the semiconductor layer 34, the source electrode 33, the drain electrode 32, the n+ layer 35, the storage capacitance line 25, the storage capacitance electrode 26 and the inorganic protective film 43 are formed on the TFT substrate 2 to provide a transistor.

In the process shown in FIG. 5B, a photolithography process is used to pattern the inorganic protective film 43 made of silicon nitride (SiN) or silicon oxide (SiO₂) so as to form a contact hole 46a above the source electrode 33 and a contact hole 47a above the storage capacitance electrode 26.

In the process shown in FIG. 5C, spin coating or the like is used to apply the organic resin film 44 over the TFT substrate 2 in which the contact holes 46a and 47a have been formed.

In the process shown in FIG. 5D, contact holes 46b and 47b are formed in the organic resin film 44 such that the contact holes 46b and 47b are aligned with the contact holes 46a and 47a, respectively. The organic resin film 44 may be formed of a photosensitive organic resin film, which can be exposed to light using a photomask and shaped into a predetermined pattern using a developer.

The organic resin film 44 is removed from the transmissive area 12, while the organic resin film 44 is left in the reflective area 11 such that the thickness of the liquid crystal layer in the reflective area 11 is half of that in the transmissive area 12 as described above.

Half exposure is used to form projections and depressions 48 in the reflective area 11. By designing the shape of the photomask to provide a greater amount of exposure to part of the organic resin film 44 and a smaller amount of exposure to the other part of the organic resin film 44 (also referred to as halftone exposure), when the organic resin film 44 is a negative type, the developer removes more organic resin film 44 from the portion that receives the smaller amount of exposure so as to form depressions.

In the process shown in FIG. 5E, a first conductive film 37 and a second conductive film 38 are successively formed on the organic resin film 44. A transparent conductive film is deposited by sputtering or the like as the first conductive film 37, while a reflective film made of aluminum or the like is deposited by sputtering or the like as the second conductive film 38.

In the process shown in FIG. 5F, to pattern the first conductive film 37 and the second conductive film 38, spin coating or the like is used to apply a photosensitive resist film 50, which is then exposed to light using a photomask and developed.

Half exposure is used to form a thick-film portion 51 and a thin-film portion 52 in the resist film 50. After the resist film is removed from the portion 53 by the developer, the thin-film portion 52 and thick-film portion 51 left in the resist film, but the film thickness of thin-film portion 52 is thinner than that of the thick-film portion 51.

In the process shown in FIG. 5G, the first conductive film 37 and the second conductive film 38 are etched away from the portion 53 where the resist film has been removed. In this process, the etching method for removing the first conductive film 37 may differ from the etching method for removing the second conductive film 38, or the same etching method is used to remove the first conductive film 37 and the second conductive film 38.

In the process shown in FIG. 5H, ashing or the like is used to remove the resist film of the thin-film portion 52. The film thickness is reduced in the thick-film portion 51 due to the ashing or the like.

In the process shown in FIG. 5I, the resist film from which the thin-film portion 52 is removed is used as a mask to etch the second conductive film 38, so that the first conductive film 37 is exposed to form the transmissive area 12.

In the process shown in FIG. 5J, the orientation film 14 is formed over the TFT substrate 2 on which the reflective area 11 and the transmissive area 12 have been formed.

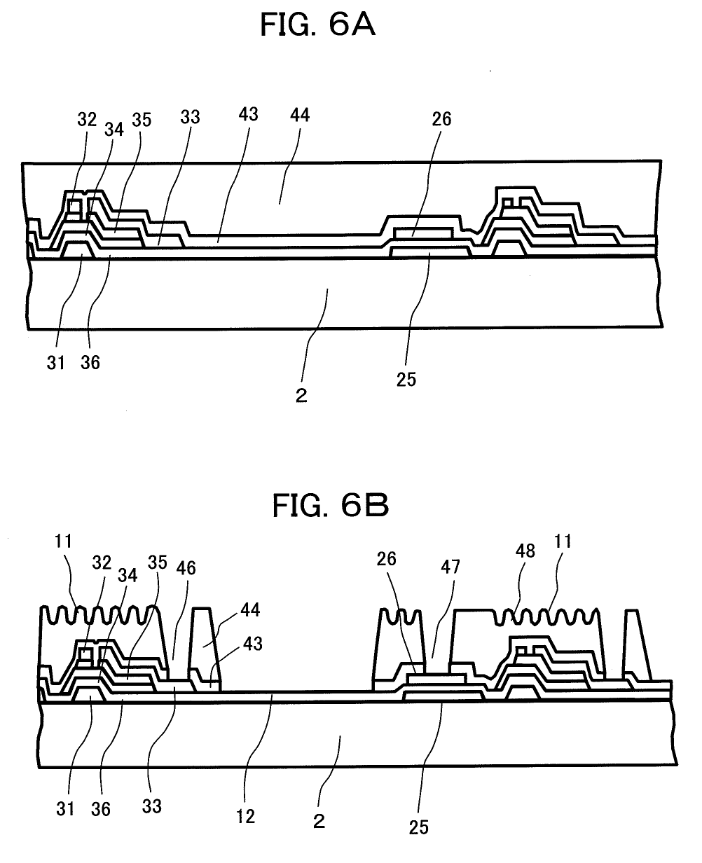

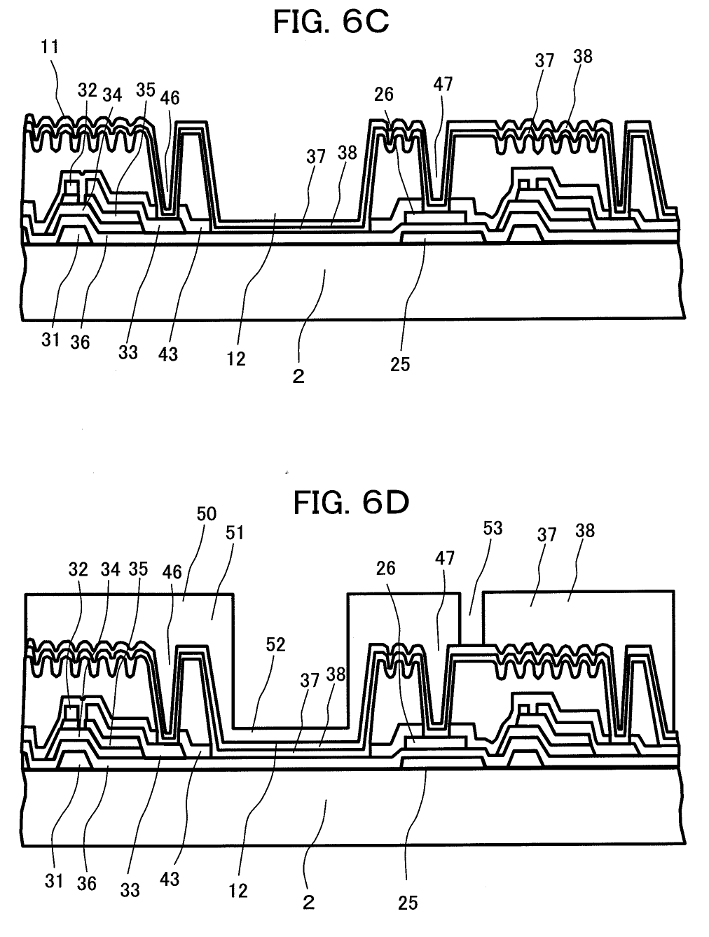

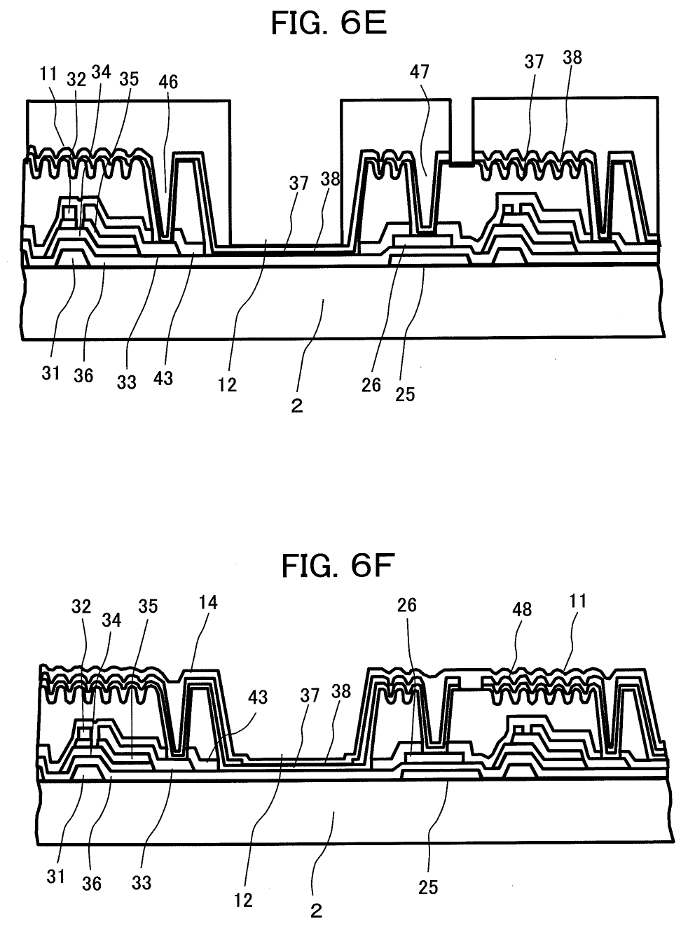

A process in which the organic resin film 44 is also used as a mask to form a contact hole in the inorganic protective film 43 will now be described with reference to FIGS. 6A to 6F.

In the process shown in FIG. 6A, the gate electrode 31, the gate insulating film 36, the semiconductor layer 34, the source electrode 33, the drain electrode 32, the n+ layer 35, the storage capacitance line 25, the storage capacitance electrode 26 and the inorganic protective film 43 are first formed on the TFT substrate 2 to provide a transistor, and then spin coating or the like is used to apply the organic resin film 44. In the process shown in FIG. 6A, the organic resin film 44 is applied on the inorganic protective film 43 having no contact hole formed therein.

In the process shown in FIG. 6B, the organic resin film 44 is exposed to light followed by development to form the contact holes 46 and 47 therein, and then the organic resin film 44 is used as a mask to etch the inorganic protective film 43. As a result, the contact hole 46 is formed above the source electrode 33 and the contact hole 47 is formed above the storage capacitance electrode 26.

In this process, as shown in the transmissive area 12, the etching will remove the inorganic protective film 43 from the portion that is not masked by the organic resin film 44.

In the process shown in FIG. 6C, the first conductive film 37 and the second conductive film 38 are successively deposited on the patterned organic resin film 44. As described in the process shown in FIG. 5E, the first conductive film 37 and the second conductive film 38 can be formed of a transparent conductive film and a metal film, respectively.

In the process shown in FIG. 6D, half exposure is used to form a resist film including portions having a certain thickness and portions having another thickness on the first conductive film 37 and the second conductive film 38. As described in the process shown in FIG. 5F, the resist film 50 includes the thick-film portion 51 and the thin-film portion 52 using half exposure.

In the process shown in FIG. 6E, the resist film 50 is used to etch the first conductive film 37 and the second conductive film 38, and then ashing or the like is used to remove the thin resist film.

In the process shown in FIG. 6F, after the thin portion 52 was removed by ashing or the like, a mask for the second conductive film 38 is formed to etch away the second conductive film 38. Then, the orientation film 14 is formed.

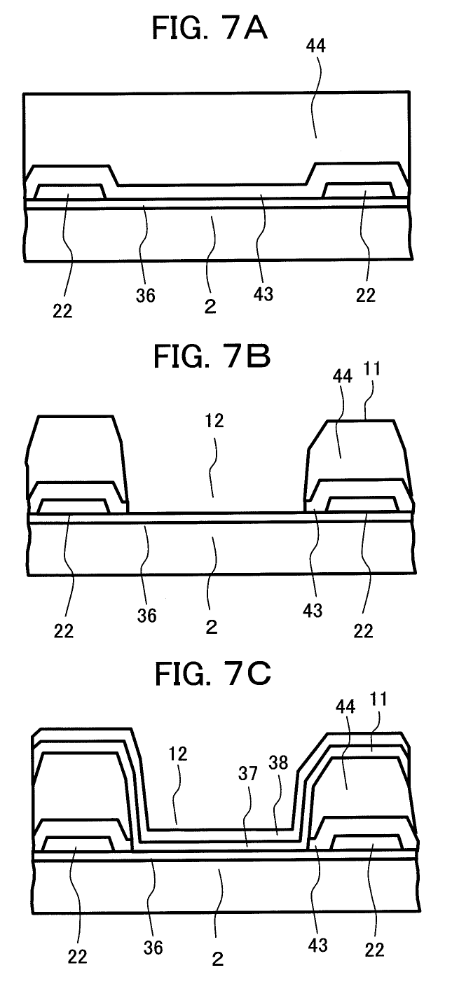

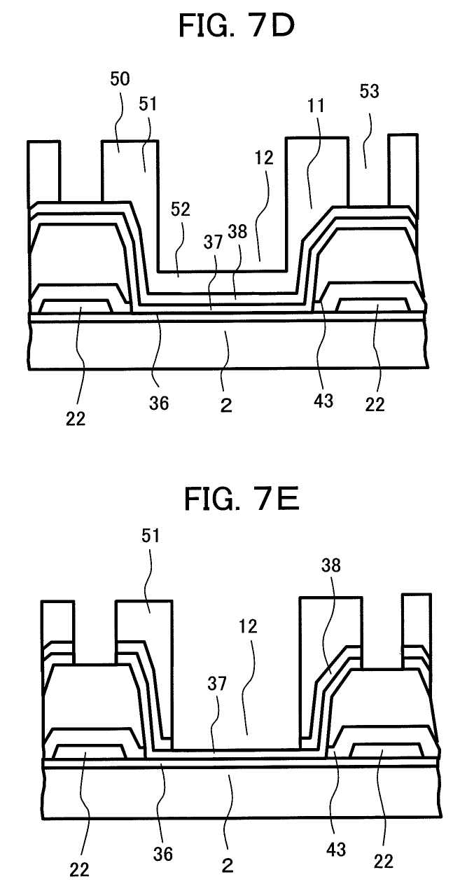

Next, a manufacturing process of the structure shown in the cross section of the TFT substrate 2-side portion taken along the line B-B in FIG. 2 will be described with reference to FIGS. 7A to 7E. In the process shown in FIG. 7A, the gate insulating film 36, the drain signal line 22 and the inorganic protective film 43 are first formed on the TFT substrate 2, and then the organic resin film 44 is applied using spin coating or the like.

In the process shown in FIG. 7B, the organic resin film 44 is exposed to light and developed to form a recess in the transmissive area 12 and a protrusion in the reflective area 11. Thereafter, the organic resin film 44 is used as a mask to remove the inorganic protective film 43. In this process, since there is no mask in the transmissive area 12 where no organic resin film 44 is provided, the inorganic protective film 43 will be removed.

In the process shown in FIG. 7C, the first conductive film 37 and the second conductive film 38 are deposited on the patterned organic resin film 44.

In the process shown in FIG. 7D, the resist film 50 is formed such that it includes the thick-film portion 51, the thin-film portion 52 and the portion 53 from which the resist film is removed. Since the thick-film portion 51 is formed at the portion surrounding the transmissive area 12, the reflective area 11 is formed such that it overlies the drain line 22.

In the process shown in FIG. 7E, ashing or the like is used to remove the thin-film portion 52, and a mask for the second conductive film 38 is formed to remove the second conductive film 38 from the transmissive area 12. Thereafter, the resist film 50 is removed and then the TFT substrate 2 is formed.

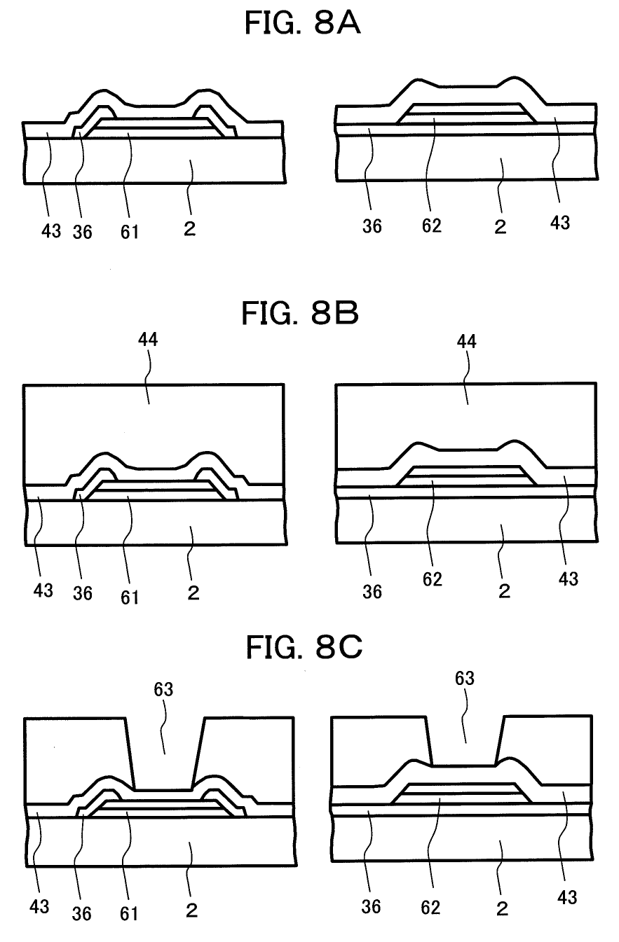

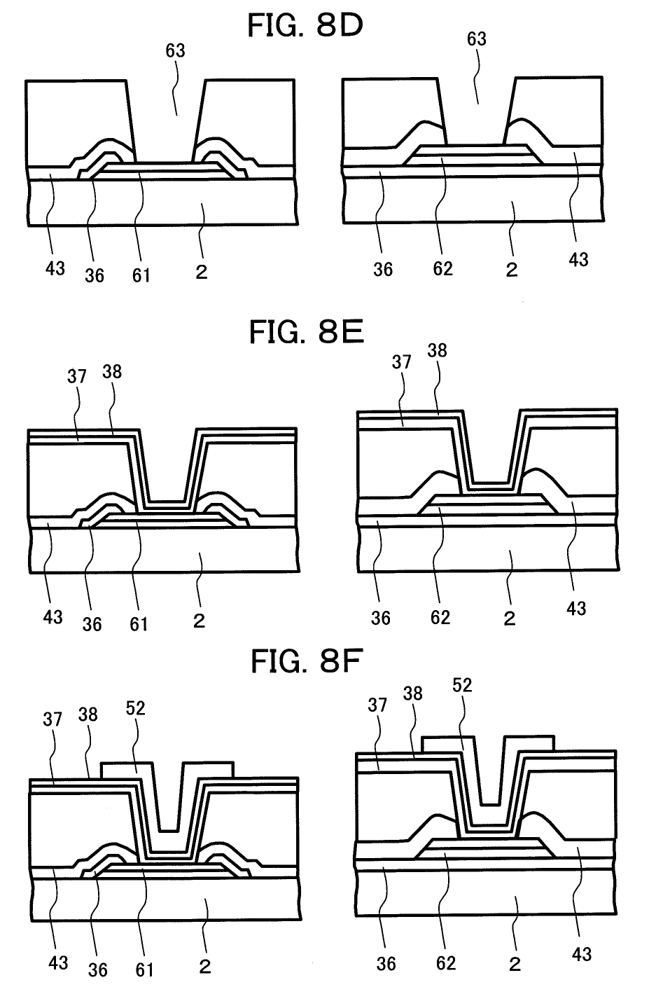

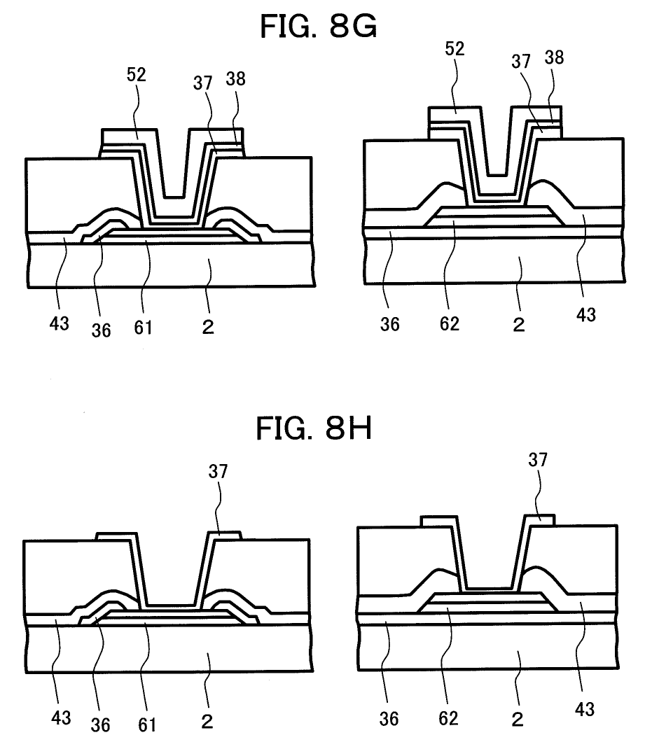

Next, the manufacturing process of external signal input terminals will be described with reference to FIGS. 8A to 8H. Reference numeral 61 shown on the left in FIGS. 8A to 8H denotes a gate terminal electrically connected to the gate signal line 21. Reference numeral 62 shown on the right in FIGS. 8A to 8H denotes a drain terminal electrically connected to the drain signal line 22. In the process shown in FIG. 8A, the protective film 43 is formed on each of the terminals.

In the process shown in FIG. 8B, spin coating or the like is used to form the organic resin film 44 over each of the terminals on which the protective film 43 has been formed.

In the process shown in FIG. 8C, the organic resin film 44 is exposed to light and developed to form a contact hole 63 on each of the terminals.

In the process shown in FIG. 8D, the organic resin film 44 is used as a mask to etch the protective film 43 so as to form the contact hole 63 in the protective film 43 on each of the terminals.

In the process shown in FIG. 8E, sputtering or the like is performed from above the organic resin film 44 to successively laminate the first conductive film 37 and the second conductive film 38.

In the process shown in FIG. 8F, a thin resist film 52 is formed such that the first conductive film 37 will be left on each of the terminals.

In the process shown in FIG. 8G, the first conductive film 37 and the second conductive film 38 are etched, so that the first conductive film 37 and the second conductive film 38 are removed except those coated with the resist film 52.

In the process shown in FIG. 8H, ashing or the like is used to remove the thin resist film 52, and then the second conductive film 38 is etched such that the first conductive film 37 is left on each of the terminals so as to form the gate terminal 61 and the drain terminal 62.

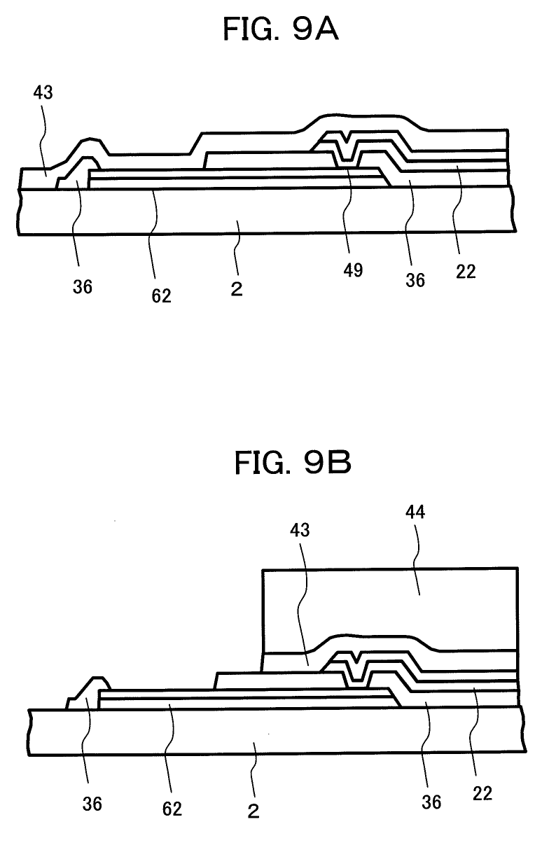

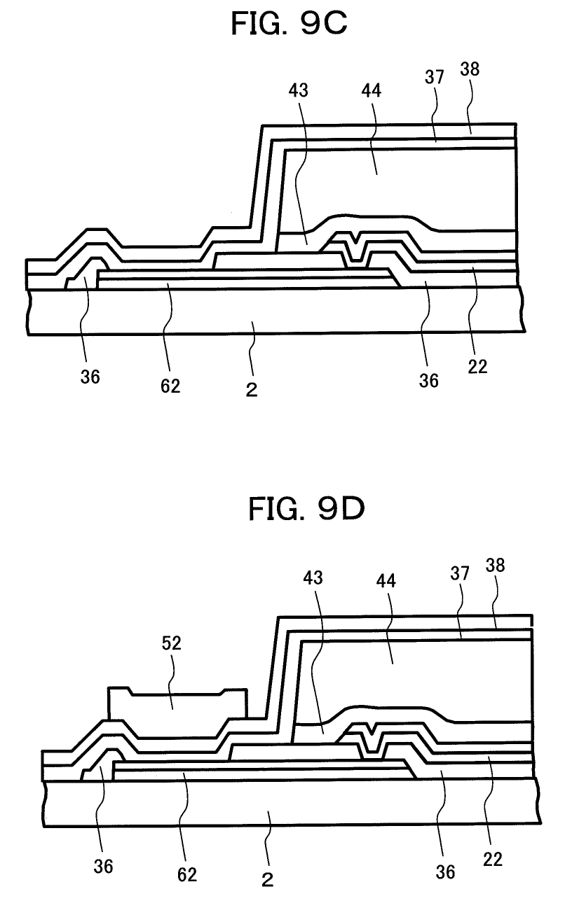

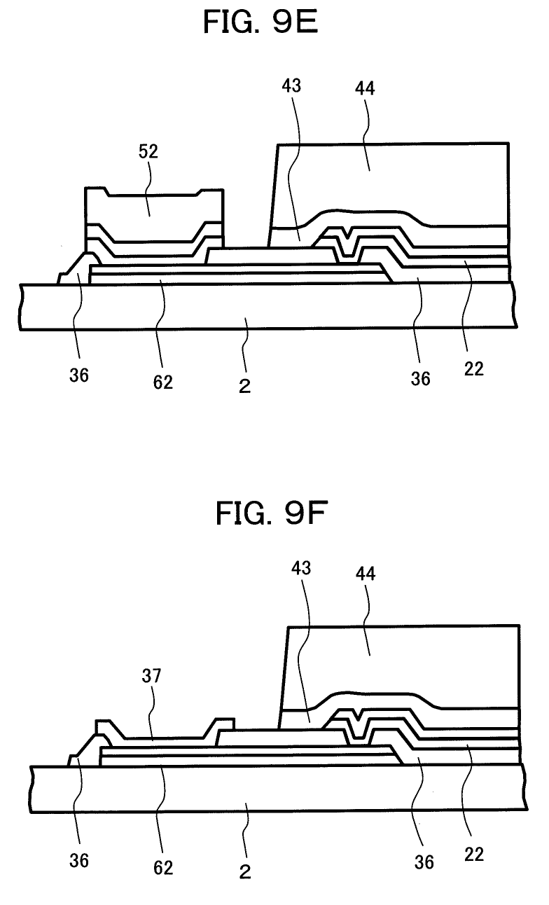

Next, a description will be made of a case where the drain terminal 62 is formed in the same process as the gate signal line 21 with reference to FIGS. 9A to 9F. FIG. 9A shows the drain terminal 62 formed in the same process as the gate signal line 21.

The drain terminal 62 is surrounded by the gate insulating film 36 and electrically connected to the drain signal line 22 via a through hole 49 formed in the gate insulating film 36.

In the process shown in FIG. 9B, the protective film 43 and the organic resin film 44 are laminated on the drain terminal 62, and then the protective film 43 and the organic resin film 44 on the drain terminal are removed.

In the process shown in FIG. 9C, the first conductive film 37 and the second conductive film 38 are laminated on the organic resin film 44. The gate insulating film 36 has been removed from the top of the drain terminal 62, so that in the process shown in FIG. 9C, the drain terminal 62 is electrically connected to the first conductive film 37 and the second conductive film 38 that is laminated on the organic resin film 44.

In the process shown in FIG. 9D, the thin resist film 52 is formed on the drain terminal 62.

In the process shown in FIG. 9E, the first conductive film 37 and the second conductive film 38 are etched away from the portion where no resist film 52 has been formed.

In the process shown in FIG. 9F, ashing is used to remove the thin resist film 52. Thereafter, the second conductive film 38 is removed such that the first conductive film 37 is left so as to form the drain terminal 62.

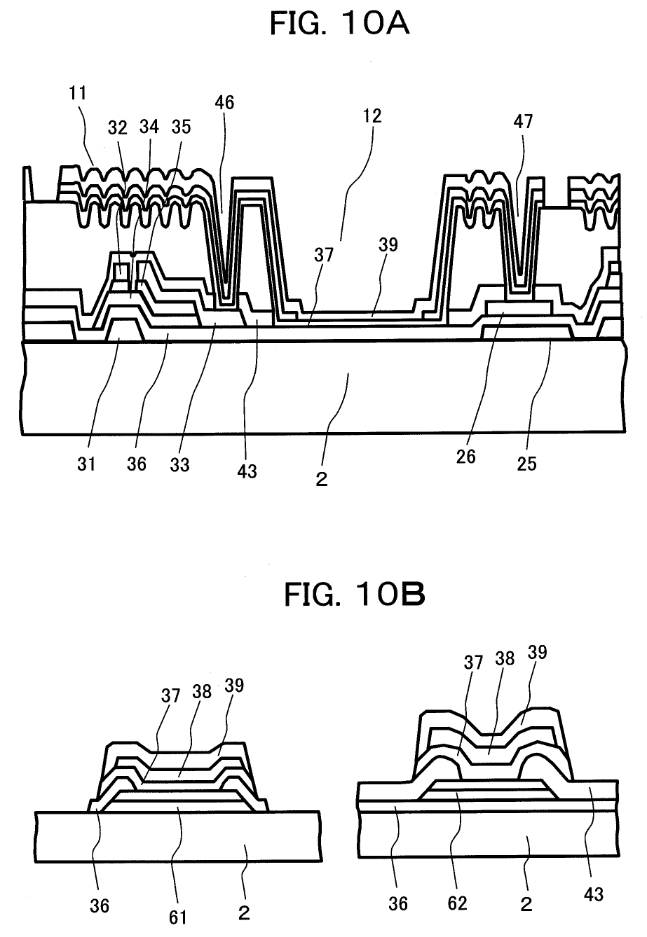

Next, FIG. 10A shows the configuration of the TFT substrate 2 on which a third conductive film 39 is laminated after a pattern for removing the second conductive film 38 was formed in the resist film 50 and the second conductive film 52 was removed. In the TFT substrate 2 shown in FIGS. 10A to 10B, a third conductive film 39 is formed as the pixel electrode in the reflective area 11 and the transmissive area 12, and the pixel electrode may be of the same material in the reflective area 11 and the transmissive area 12.

As shown in FIG. 10B, the third conductive film 39 can surround the second conductive film 38. When the second conductive film 38 is made of material subject to corrosion, reliability can be improved by using anti-corrosion material for the third conductive film 39.

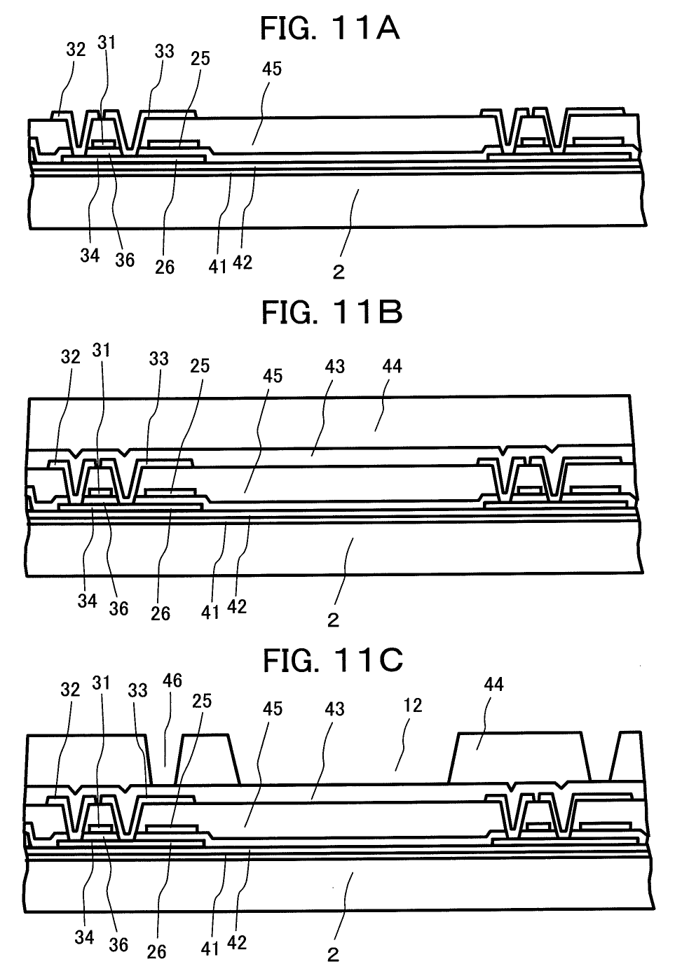

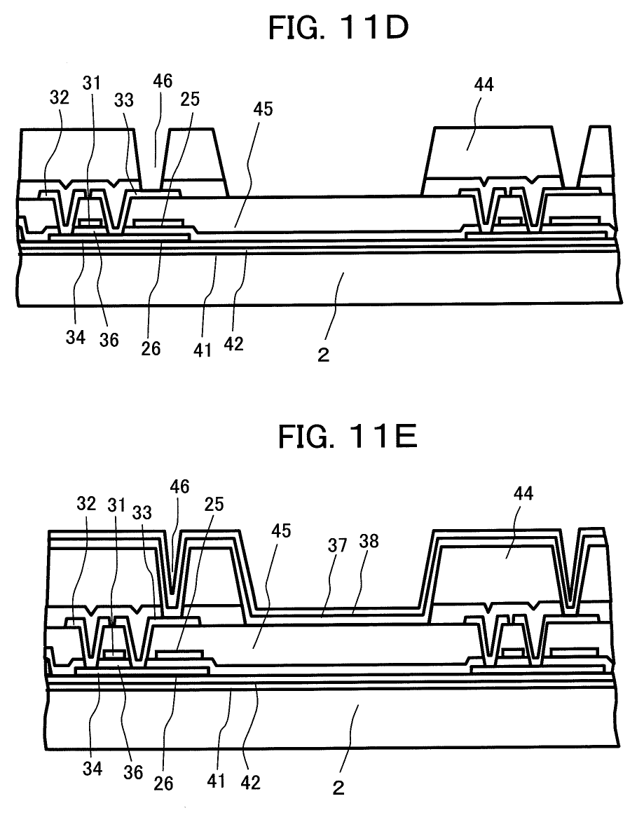

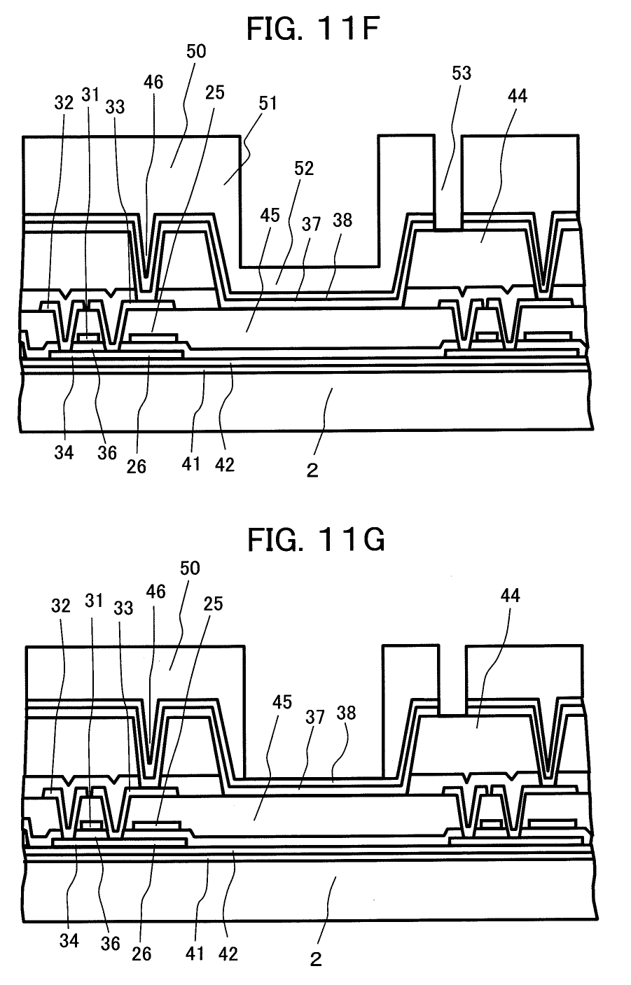

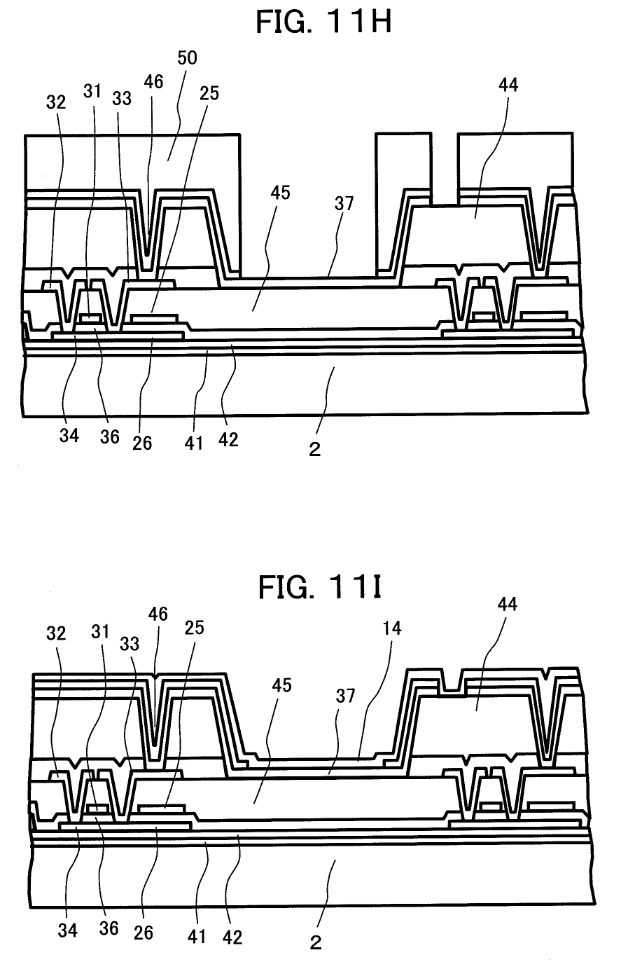

Next, a method for manufacturing a liquid crystal display device in which the semiconductor layer is made of polysilicon will be described with reference to FIGS. 11A to 11I. In the process shown in FIG. 11A, a first underlying film 41 and a second underlying film 42 are formed on the TFT substrate 2, and then the semiconductor layer 34 is formed thereon. Thereafter, thermal annealing or the like is used to apply energy to the semiconductor layer 34 so as to grow crystals, resulting in a so-called impurity doped polysilicon transistor. On the semiconductor layer 34, the gate electrode 31, the gate insulating film 36, the source electrode 33, the drain electrode 32 and an interlayer insulating film 45 are formed. Part of the semiconductor layer to which conductivity has been imparted is used as the storage capacitance electrode 26, and the storage capacitance line 25 is formed in the same layer as the gate electrode 31.

In the process shown in FIG. 11B, the protective film 43 is formed on the polysilicon transistor structure, and spin coating or the like is used to apply the organic resin film 44.

In the process shown in FIG. 11C, the organic resin film 44 is exposed to light followed by development to form the contact hole 46 in and an aperture, corresponding to the thickness of the liquid crystal layer, in the transmissive area 12.

In the process shown in FIG. 11D, the organic resin film 44 is used as a mask to etch the inorganic protective film 43. In this process, as shown in the transmissive area 12, the inorganic protective film 43 will be etched away not only in the contact hole 46 but also in the area that is not masked by the organic resin film 44.

In the process shown in FIG. 11E, the first conductive film 37 and the second conductive film 38 are successively deposited on the patterned organic insulating film 44. The first conductive film 37 and the second conductive film 38 can be formed of a transparent conductive film and a metal film made of aluminum or the like, respectively.

In the process shown in FIG. 11F, half exposure is used to form a resist film including portions having a certain thickness and portions having another thickness on the first conductive film 37 and the second conductive film 38. The resist film 50 includes the thick-film portion 51 and the thin-film portion 52 depending on the amount of the exposure that the resist film 50 has received.

In the process shown in FIG. 11G, the resist film 50 is used to etch the first conductive film 37 and the second conductive film 38, and then ashing or the like is used to remove the thin resist film.

In the process shown in FIG. 11H, after the thin portion 52 was removed by ashing or the like, a mask for the second conductive film 38 is formed to etch away the second conductive film 38.

In the process shown in FIG. 11I, after the second conductive film 38 was removed from the transmissive area 12, the resist film 50 is removed and the orientation film 14 is applied to form the TFT substrate 2.

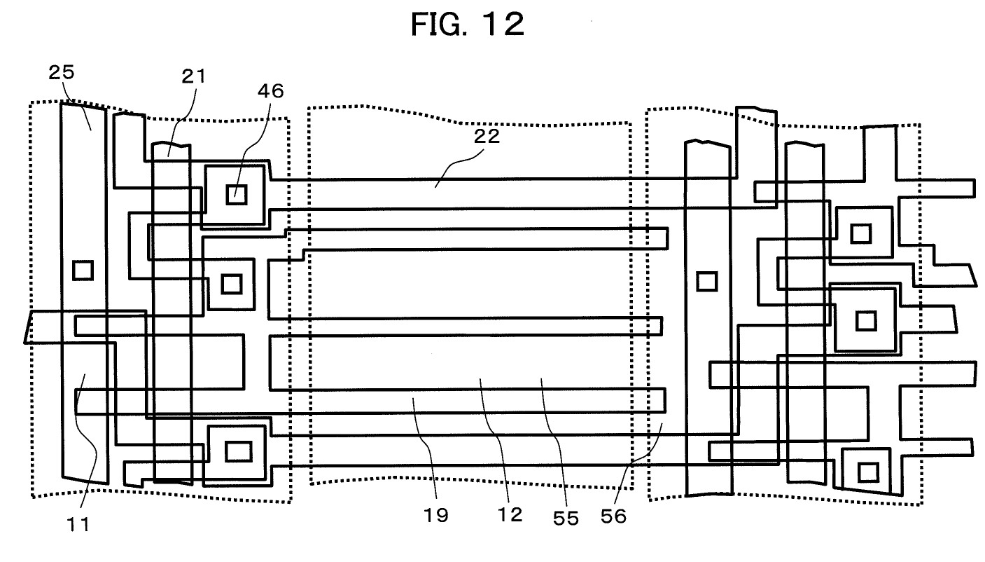

Next, FIG. 12 is a schematic plan view of the pixel section of the IPS liquid crystal display device. The pixel shown in FIG. 12 has a planar counter electrode formed under a comb electrode 19. A transparent conductive film is used to form a counter electrode 55 in the transmissive area 12, and a metal film is used to form a reflective film 56 in the reflective area 11.

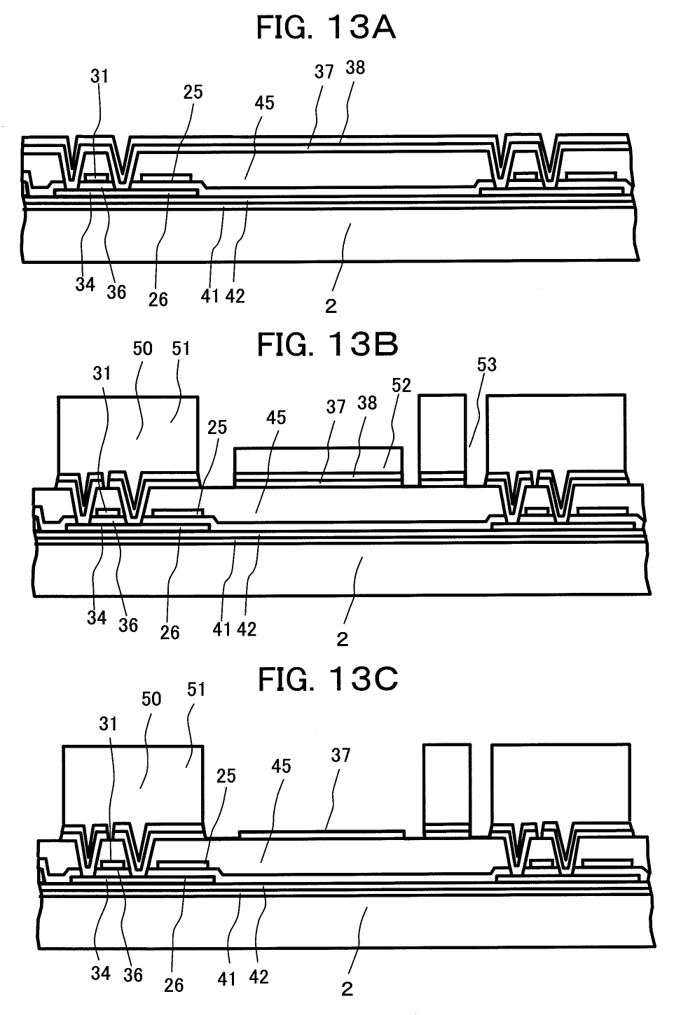

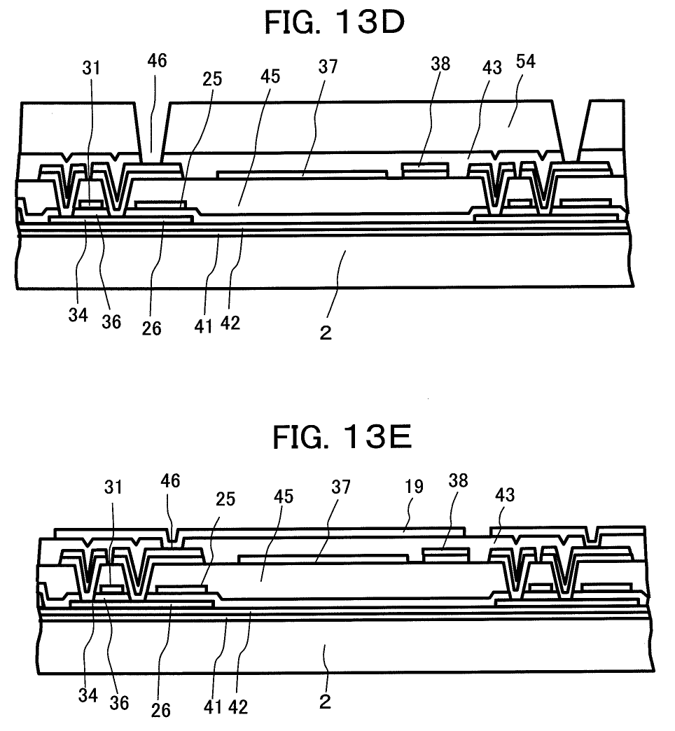

A method for manufacturing a polysilicon-based IPS TFT substrate will be described with reference to FIGS. 13A to 13E. In FIGS. 13A to 13E, the transparent conductive film formed in the transmissive area 12 is the first conductive film 37, and the reflective film 56 formed in the reflective area 11 is the second conductive film 38.

In the process shown in FIG. 13A, the interlayer insulating film 45 is formed on the TFT substrate 2, and the first conductive film 37 and the second conductive film 38 are laminated on the interlayer insulating film 45.

In the process shown in FIG. 13B, half exposure is used to form a resist film including portions having a certain thickness and portions having another thickness on the first conductive film 37 and the second conductive film 38. Then, the first conductive film 37 and the second conductive film 38 are etched away from the portion 53 where no resist film 50 has been formed.

In the process shown in FIG. 13C, ashing or the like is used to remove the thin portion 52, so that a mask for the second conductive film 38 is formed to etch away the second conductive film 38.

In the process shown in FIG. 13D, the first conductive film 37 and the second conductive film 38 are patterned, on which the protective film 43 and a resist film 54 are formed. Then, the resist film 54 is exposed to light and developed, and the resist film 54 is used as a mask to etch the inorganic protective film 43 so as to form the contact hole 46.

In the process shown in FIG. 13E, the comb electrode 19 is deposited on the protective film 43, and then etched and patterned.

As described above, according to the invention of this application, in the liquid crystal display device with the reflective area 11 and the transmissive area 12, by forming the first conductive film 37 that forms the transparent electrode and the second conductive film that forms the reflective electrode, forming the thick-film portion 51 and the thin-film portion 52 in the resist film 50, and using ashing to remove the thin-film portion 52 so as to form a mask for etching the second conductive film 38, it is possible to prevent the number of processes from increasing. In addition, according to the invention of this application, by using the organic resin film 44 as a mask for forming the contact hole in the inorganic protective film 43, the number of processes can be reduced.

What is claimed is:

1. A method for manufacturing a display device having pixels arranged in a matrix, the method including the steps of:
forming source electrodes on a substrate;
laminating a first insulating film and a second insulating film on the source electrodes;
forming a contact hole in the first and second insulating films;
laminating a first conductive film and a second conductive film on the first and second insulating films and connecting the source electrode to the first conductive film via the contact hole;
using a first pattern of a resist film to etch the first and second conductive films;
removing part of the resist film to form a second pattern; and
using the second pattern to etch the second conductive film.

2. A method for manufacturing a display device according to claim 1, wherein the second pattern is used to form a transmissive area.

3. A method for manufacturing a display device according to claim 1, wherein the display device has a reflective area and a transmissive area and the second pattern is used to form the transmissive area.

4. A method for manufacturing a display device having pixels arranged in a matrix on a substrate, the method including the steps of:
forming a source electrode in each of the pixels;
laminating a first insulating film and a second insulating film on the source electrode;
forming a contact hole in the second insulating film;
using the contact hole formed in the second insulating film to remove the first insulating film on the source electrode;
laminating a first conductive film and a second conductive film on the first and second insulating films and connecting the source electrode to the first conductive film via the contact hole;
using a first pattern of a resist film to etch the first and second conductive films;
removing part of the resist film to form a second pattern; and
using the second pattern to etch the second conductive film.

5. A method for manufacturing a display device according to claim 4, wherein the second pattern is used to form a transmissive area.

6. A method for manufacturing the display device according to claim 4, wherein the display device has a reflective area and a transmissive area and the second pattern is used to form the transmissive area.

7. A method for manufacturing a display device having pixels arranged in a matrix on a substrate, the method including the steps of:
forming a source electrode in each of the pixels;
forming a first insulating film on the source electrode;
laminating a second insulating film made of resin on the first insulating film;
exposing the second insulating film to light followed by development to form a pattern having a first contact hole in the second insulating film;
using the pattern having the first contact hole to form a second contact hole in the second insulating film;
laminating a first conductive film and a second conductive film on the first and second insulating films and connecting the source electrode to the first conductive film via the first and second contact holes;
applying a resist film on the first and second conductive films;
exposing the resist film to light followed by development to form a first pattern;
using the first pattern of the resist film to etch the first and second conductive films;
using ashing to remove part of the resist film to form a second pattern; and
using the second pattern to etch the second conductive film.

8. A method for manufacturing a display device according to claim 7, wherein the second pattern is used to form a transmissive area.

9. A method for manufacturing a display device according to claim 7, wherein the display device has a reflective area and a transmissive area and the second pattern is used to form the transmissive area.
